(19) United States
(12) Patent Application Publication
(10) Pub. No.: US 2018/0360252 A1
(43) Pub. Date: Dec. 20, 2018

(54) TREE NEEDLE CATCHER AND DISPOSAL APPARATUS

(71) Applicant: Le-Ann Anderson, Haverhill, MA (US)

(72) Inventor: Le-Ann Anderson, Haverhill, MA (US)

(21) Appl. No.: 16/008,468

(22) Filed: Jun. 14, 2018

Related U.S. Application Data
(60) Provisional application No. 62/519,221, filed on Jun. 14, 2017.

(51) Int. Cl. A47G 33/04

(52) U.S. Cl. CPC A47G 33/045; A01G 13/043

(57) ABSTRACT

Apparatus is provided for catching falling leaves including needles from trees, and for enclosing trees for transport and disposal. The apparatus presented comprise a collar-style container for attachment to a tree's trunk, leaf or needle catcher material, clips or other components for securing the catcher material to the tree, which catcher material may surround the tree, and means to close the catcher material to enclose the tree. A user may use the apparatus to maintain a tidy space under and around a tree while the tree is present in the user's chosen place, and to keep the tree's leaves or needles from falling throughout the user's home while the tree is being removed. The present invention solves problems with the currently available means of keeping the area around a tree and the objects under the tree tidy, and with disposal of the tree.

### FIELD OF THE INVENTION

The presently disclosed subject matter relates to providing apparatus for catching tree leaves or needles and enclosing a tree for disposal.

### BACKGROUND OF THE INVENTION

It is traditional and customary for many people to place a tree inside their homes for a week or more, usually during December as a Christmas tree. While some people use artificial trees for various reasons, actual cut evergreen trees, typically pine or spruce, are preferred for appearances, the scent of the tree, and custom. Trees, after they have been cut, slowly dry out, and during the time that they are in someone's home, a tree typically sheds many of its needles, or other leaves. These tend to fall all over the presents that families arrange under a Christmas tree, and to bounce around. While there exist devices that attempt to contain the needles after they have landed on the ground or on the presents, these have shortcomings of aesthetics—as they require a sheet or mat to be spread on the ground all around the tree, with the presents placed on them—and shortcomings of function—as they allow needles to bounce away off of the device, and to remain on the presents and be deflected away from the tree and the sheet by the presents.

Furthermore, when the tree is removed from the home, it has nearly always dried out further, and sheds needles readily as it is moved. This tends to spread needles throughout the home, making for a tedious and time-consuming clean-up job. There are devices known in the art for bagging trees to enclose them, but they present shortcomings of aesthetics, effectiveness in containing needles, and simplicity of placing the device on the tree and using it to enclose the tree and dispose of the tree. For instance, U.S. Pat. No. 4,206,795 to Regan discloses a bag secured in a container that is placed around the trunk of a tree, but the bag in Regan presents problems of aesthetics (the bag is to be draped on the floor, where it is unsightly to many users, and therefore a less-appealing product) and of effectiveness (as needles can bounce off of the bag or presents, and on to the floor, making it an ineffective product, and some of the needles will likely remain on presents and thus be scattered when the presents are taken out from under the tree). Likewise, U.S. Pat. No. 4,899,878 to Lofton discloses flat sheeting placed under the tree, with a hole in the center, with the same problems of aesthetics and effectiveness. US patent application 20040262183 by Gildart discloses a reusable bag that may be spread as a tree skirt in to parts under a tree, and then is zipped or otherwise closed to form a bag for transport; and PCT/NO2004/000246 (published as WO2005016086B1) by Wolsund presents an apparatus with a bag with multiple components. These approaches present the same problems of aesthetics and effectiveness by presenting a floor-level tree skirt, and also introduce problems of enclosing the tree without spilling the needles out when closing the parts of the tree skirt to form a bag, and has shortcomings in presenting a reusable bag, such as the need to remove it without damaging it. Other prior art exists for transporting trees (for instance, Chinese Utility Model CN2897853Y to Tong, U.S. Pat. No. 9,578,814 to Belschner, German Utility Model DE202010000911 to Peau), but none solve the problems of aesthetics, effectiveness, and ease of use.

Additionally, the present art for wrapping and bagging trees for disposal interferes with composting the trees by presenting bag or container material which is not compostable.

### SUMMARY OF THE INVENTION

The present invention meets all these needs, by disclosing apparatus a tree needle catcher and disposal, by placement about the trunk of a tree before the tree is raised in a home, which apparatus is then opened and engaged to catch needles as they fall without requiring a sheet or mat placed around the tree on the floor. The present invention relates broadly to bags, and more particularly to an enclosure for enclosing a decorative tree placed in a home, by placing a container containing the bag material around the trunk of the tree, partially extending the bag material (to catch falling needles or leaves), and later fully extending the bag material to enclose the tree. The device is simple to install and open to catch needles. The goal of the present invention is to provide a solution for catching and containing needles or leaves that fall from the tree during the time it is present in a user's home, without creating an undesirable aesthetic appearance due to the bag material or catchment solution. The present invention further addresses the problem of making a mess by knocking many needles off the tree as the tree is removed from the home, by presenting means to enclose the tree simply and securely by extending the needle-catchment portion of the device up and over the tree, and securing the open end to close the tree in.

The present invention addresses the problems of aesthetics of the current art in catching needles, by presenting a needle catchment portion of the presently disclosed apparatus that in unobtrusive, thin, may be transparent or colored to blend in with trees, and is secured to the tree itself—specifically, it has been found advantageous, to the lowest branches of the tree at their distal ends, away from the tree trunk, such that the needle catchment portion of the present invention hangs in the air directly under the tree's branches, rather than being a sheet or mat to spread over a large area beyond the extent of the tree's branches. This type of attachment of the needle catchment portion of the apparatus is more effective at catching needles than other devices known in the art, because the needles don't fall as far, and when they bounce, they are bouncing off of a suspended surface of the bag material or apparatus, that will flex upon a needle hitting it, rather than a likely more-elastic floor that will cause needles to bounce and more likely bounce out of the sheet area (when using devices of the prior art). Additionally, the needles won't be falling as far as the floor, and if they do bounce they are likely to hit a tree branch and be blocked from falling out of the needle catchment portion of the present invention and onto the floor. The present invention will also keep needles off of the presents that are traditionally placed under the tree, which occurs with the prior art devices that have sheets of material sitting on the floor, because the present invention provides a catchment material in the air above the presents.

Further, the present invention introduces a product that is easier to use than the current art of tree needle or tree leaf catchment, by clamping around the trunk of a tree, quickly securing the to lowermost branches of the tree, and then being quickly pulled up and disposed around the tree, rather than being zipped or formed or otherwise closed around a tree. In this way, the present invention presents improvements in consumer choice and options for maintaining desired tidiness under and around a tree and on presents or other objects under the tree, and for facilitating and reducing the time required for cleanup around the tree and on the egress path from the home after removal of the tree. Additionally, the present invention discloses apparatus that can serve the functions disclosed herein while being made of biodegradable materials, or having only biodegradable materials remain with the tree, allowing the tree to be passed to a location for chipping or composting or other biological disposal. This will make the use of the products disclosed herein more attractive to a large segment of consumers who wish to solve the problems described above with the present art of tree presentation and disposal, but do not wish to have the tree container preclude the tree from being chipped, composted, or otherwise biologically disposed of.

The present invention may also be used as a storage device for an artificial tree, which allows a user of such an artificial tree to leave lights and decorations on the artificial tree, and secure them with the tree inside the storage enclosure of the present invention.

These aspects of the present invention, and others disclosed in the Detailed Description of the Drawings, represent improvements on the current art. This summary is provided to introduce a selection of concepts in a simplified form that are further described below in the Detailed Description of the Drawings. This Summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of various embodiments, is better understood when read in conjunction with the appended drawings. For the purposes of illustration, the drawings show exemplary embodiments; but the presently disclosed subject matter is not limited to the specific methods and instrumentalities disclosed. In the drawings, like reference characters generally refer to the same components or steps of the device throughout the different figures. In the following detailed description, various embodiments of the present invention are described with reference to the following drawings, in which:

FIG. 1 shows a front and top perspective view of an embodiment of the apparatus of the present invention, with the container of the apparatus not yet opened.

FIG. 2 shows a front and top perspective view of the embodiment of FIG. 1 of the apparatus of the present invention, with the enclosure of the apparatus opened to reveal the bag material inside the container.

FIG. 3 shows a perspective view of the embodiment of FIG. 1 of the apparatus as placed on an exemplary tree, with the bag material not yet pulled out of the container.

FIG. 4 shows a cross-sectional view through the center of the embodiment of FIG. 1 of the apparatus of the present invention and through the trunk of an exemplary tree on which the apparatus has been placed, showing in cross-section the bag material extended up and attached to the lower branches of the exemplary tree.

FIG. 5 shows a perspective view of the embodiment of FIG. 1 of the apparatus of the present invention placed on the trunk of an exemplary tree, showing the bag material extended up and attached to the lower branches of the exemplary tree.

FIG. 6 shows a perspective view of the embodiment of FIG. 1 of the apparatus of the present invention placed on the trunk of an exemplary tree, showing the bag material extended up and around the branches of the exemplary tree, with the bag material closed at or above the top of the exemplary tree.

FIG. 7 shows a front and top perspective view of an embodiment of the apparatus of the present invention, with the container of the apparatus not yet opened.

FIG. 8 shows a cross-sectional view through the center of the apparatus of the present invention, of the embodiment presented in FIG. 7, and through the trunk of an exemplary tree on which the apparatus has been placed, showing in cross-section the bag material extended up and attached to the lower branches of the exemplary tree.

FIG. 9 shows a front and bottom perspective view of an embodiment of the apparatus of the present invention, with the container of the apparatus not yet opened.

FIG. 10 shows a cross-sectional view through the center of the apparatus of the present invention, of the embodiment presented in FIG. 9, and through the trunk of an exemplary tree on which the apparatus has been placed, showing in cross-section the bag material extended up and attached to the lower branches of the exemplary tree.

### DETAILED DESCRIPTION OF THE DRAWINGS

The presently disclosed invention is described with specificity to meet statutory requirements. But, the description itself is not intended to limit the scope of this patent. Rather, the claimed invention might also be embodied in other ways, to include different steps or elements similar to the ones described in this document, in conjunction with other present or future technologies. Moreover, although the term “step” or similar terms may be used herein to connote different aspects of methods employed, the term should not be interpreted as implying any particular order among or between various steps herein disclosed unless and except when the order of individual steps is explicitly described.

In the following description, numerous specific details are set forth to provide a thorough understanding of the invention. But, the present invention may be practiced without these specific details. Structures and techniques that would be known to one of ordinary skill in the art have not been shown in detail, in order not to obscure the invention. Referring to the figures, it is possible to see the various major elements constituting the apparatus and methods of use the present invention.

The present invention comprises a novel apparatus for tree needle or leaf catchment and tree transport through a house, or other areas where it is desired that the needles or leaves of the tree not fall and scatter throughout the area.

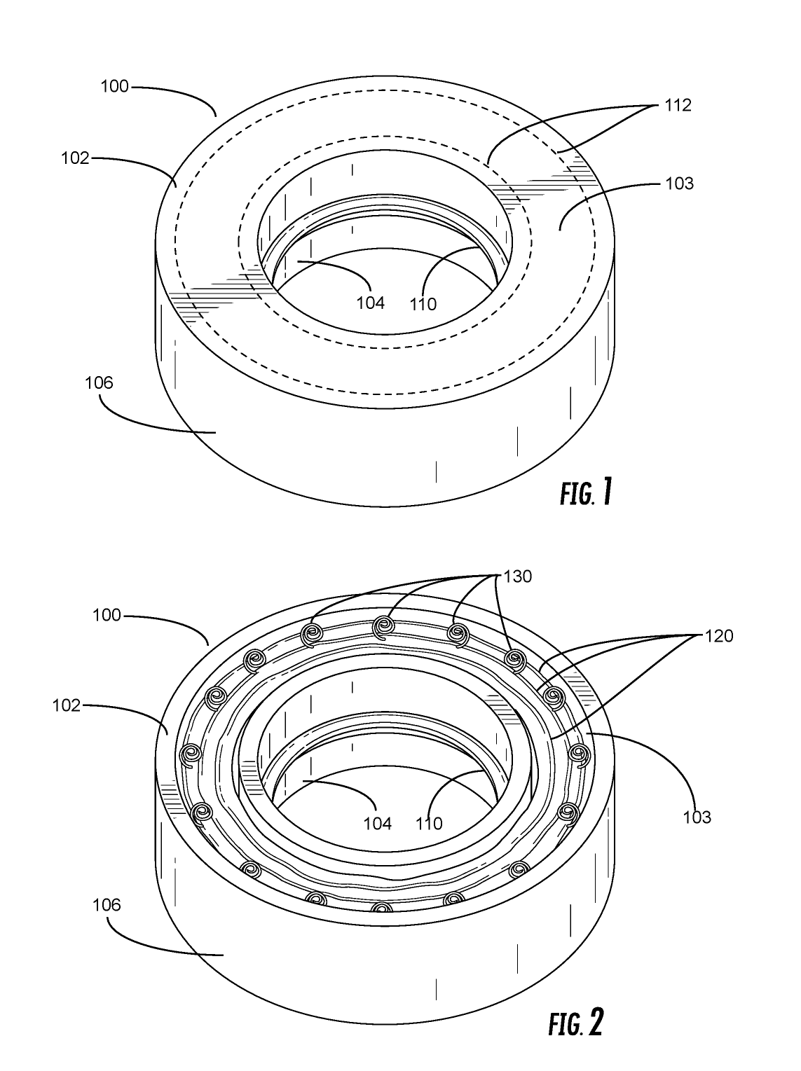

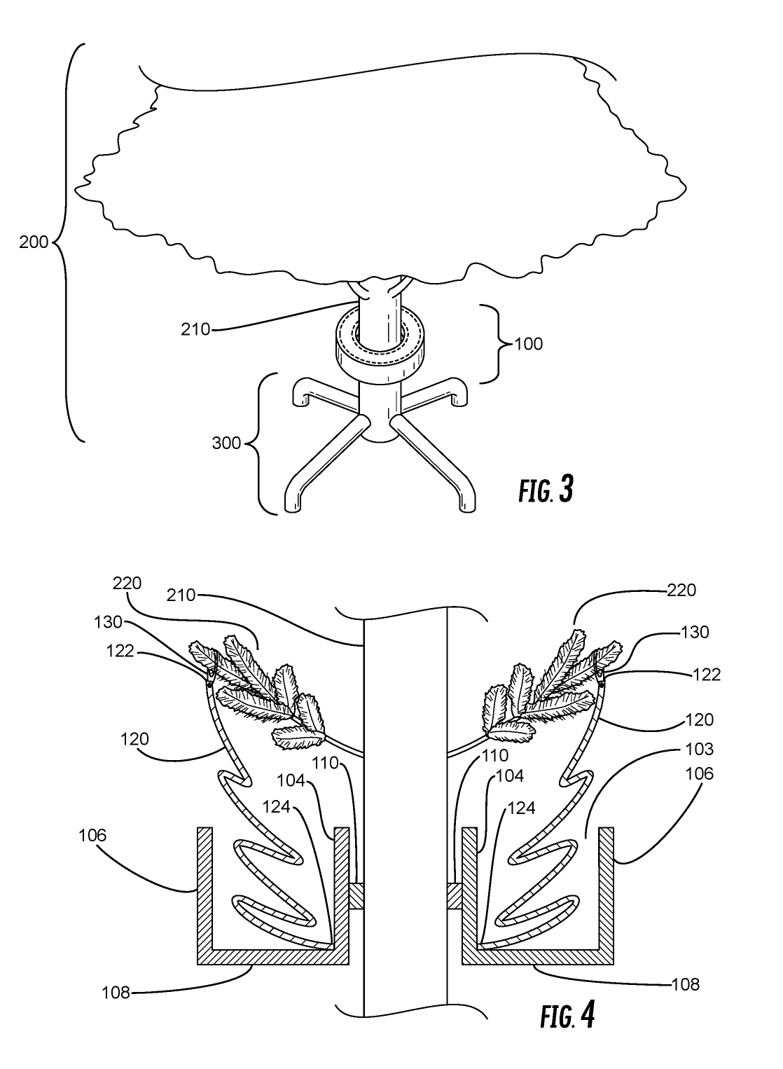

With reference to FIGS. 1 and 2, the present invention comprises an apparatus 100. The apparatus 100 comprises a top 102, an inner wall 104, an outer wall 106, and a bottom 108, all of which are joined to create a hollow shape, which shape of apparatus 100, it has been found advantageous, may be shaped as a hollow cylinder, a hollow torus, or other suitable hollow shape, which may be referred to as a container. The space inside of the inner wall 104 of the apparatus 100 is suitably sized for having the apparatus 100 placed around a tree trunk 210 of a tree 200, as described below.

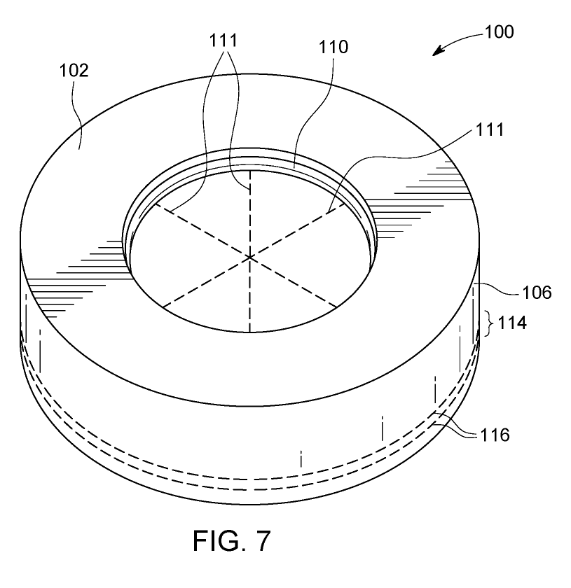

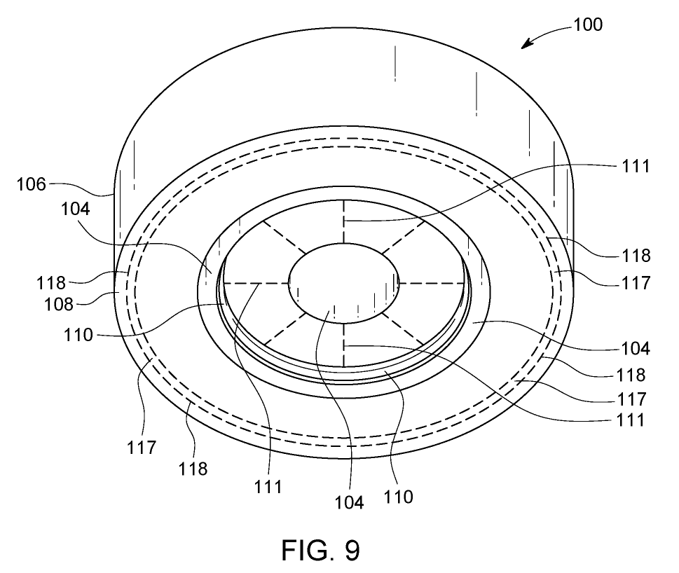

The apparatus 100 further comprises a central closure and support 110 fixedly attached to the inner wall 104 and extending inward from the inner wall 104, that is, into the empty space in the center of the hollow shape of the apparatus 100. The goals of the central closure and support 110 are to attach and hold the apparatus 100 to the tree trunk 210 of the tree 200 (supporting the weight of the apparatus 100, the bag material 120, and any a plurality of tree needles 230 that fall onto it, described below), and to serve as a seal between the tree trunk 210 and the remainder of the apparatus 100, such that a plurality of tree needles 230 cannot fall past the apparatus 100, as is described in greater detail below. It will be understood by one of skill in the art that suitable materials for use as the central closure and support 110 are flexible enough to conform to the shape of the tree trunk 210 and keep the plurality of tree needles 230 from falling down through the center of the apparatus 100, and strong enough to stably support the apparatus 100 to hold the apparatus 100 in place on the tree trunk 210, for the duration of the time the tree 200 is placed in the home or other location by a user of the apparatus 100. Such suitable materials may include but are not limited to neoprene, silicone, cardboard or other paper or cellulose products, and plastics. The central closure and support 110 may comprise one piece or sheet or layer of material, as shown in FIG. 1, FIG. 2, and FIG. 4. Alternatively, as is shown in FIGS. 7-10, the central closure and support 110 may comprise one or more layers of material, which may be disposed on the inner wall 104 towards the top 102 (as in FIG. 7) and/or towards the bottom 108 (as in FIG. 9), or near to each other, and extend inward into the space in the middle of the apparatus 100, into which space the tree trunk 210 is disposed when the apparatus 100 is moved onto the tree trunk 210. Whether the central closure and support 110 comprises one or more than one pieces of material, the material comprising the central closure and support 110 may be a solid sheet (as in FIGS. 1 and 2), and/or may be perforated (as in FIG. 7 and FIG. 9) with a plurality of central closure and support perforations 111, and/or may have a hollow opening in the center of the central closure and support 110 (as in FIG. 9), and/or may be continuous across the space inside the inner wall 104 (as in FIG. 7). Where there is more than one sheet or piece of material comprising the central closure and support 110, the one or more sheets or pieces need not be identical. Where the central closure and support 110 further comprises the plurality of central closure and support perforations 111, it will be understood by one of skill in the art that the plurality of central closure and support perforations 111 allows the central closure and support 110 to be custom fit to the tree trunk 210 to which the apparatus 100 is being fit, by creating or enlarging an opening that fits the tree trunk 210 through the opening in the middle of the apparatus 100 (that is, inside of the inner wall 104), with the central closure and support 110 maintaining sufficient contact with the tree trunk 210 to provide sufficient friction and frictive contact with the tree trunk 210 to support the weight of the apparatus 100. The plurality of central closure and support perforations 111 may be arranged so that when a sheet of the central closure and support 110 is separated along the plurality of central closure and support perforations 111, the separated portions of the central closure and support 110 are formed as separate shapes, which may be triangles, squares, rectangles, trapezoids, circular arc sections, or other shapes, which shapes are pointing down along the tree trunk 210, and resist sliding down the tree trunk 210, providing the force that holds the weight of the apparatus 100 up and in place on the tree trunk 210. The material comprising the central closure and support 110 may require relatively more or fewer such perforations in the plurality of central closure and support perforations 111, depending on the material of the central closure and support 110, and its plasticity or elasticity, as will be understood by one of skill in the art.

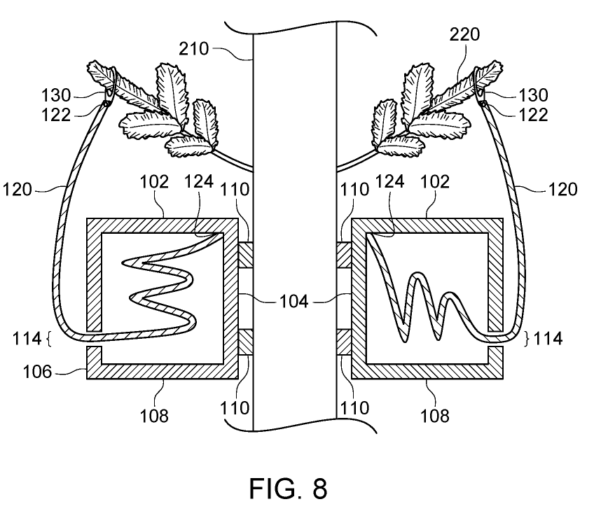

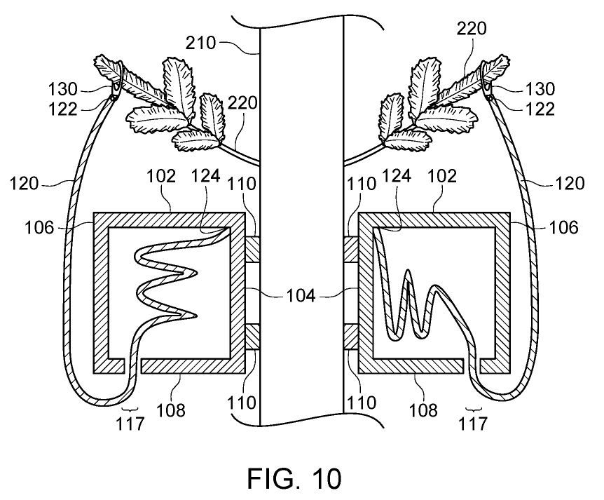

The apparatus 100 further comprises bag material 120 inside the apparatus 100, which bag material 120 is initially folded inside the apparatus 100. It has been found advantageous to have the bag material 120 formed as a cylindrical sheet of material. In some embodiments of the present invention, as shown in FIGS. 1-6, the top 102 or a portion of the top 102 may be removed along top removal perforations 112, creating the top opening 103 and allowing the user to access the bag material 120 inside the remaining walls of the shape of the apparatus 100, through the top opening 103. In other embodiments of the present invention, the opening in the apparatus 100 may be in the outer wall 106, as shown in FIGS. 7-8, with an outer wall opening 114 created by removal of a portion of the outer wall 106 along a set of outer wall removal perforations 116. In other embodiments of the present invention, as shown in FIGS. 9-10, a bottom opening 117 may be created by removal of a portion of the bottom 108 along a set of bottom removal perforations 118 in the apparatus 100. It will be understood by one of skill in the art that a suitable opening may be formed or created in the inner wall 104 of the apparatus 100, in some embodiments of the present invention.

The bag material 120, it will be understood by one of skill in the art, is advantageously a plastic or other flexible material that is impervious to tree leaves or needles, and which is sufficiently resistant to being punctured that it will not be perforated by the branches of a tree when it is used to enclose a tree. The bag material 120 is disposed inside the apparatus 100 with a bag leading edge 122 of the bag material 120 exposed and visible when the top 102 is removed along the top removal perforations 112, or when the outer wall opening 114 is created by removal of the portion of the outer wall 106 along the set of outer wall removal perforations 116, or when the bottom opening 117 is created by removal of a portion of the bottom 108 along a set of bottom removal perforations 118 in alternative embodiments of the present invention, or the bag leading edge 122 may be exposed and visible through the suitable opening in the apparatus 100 that is formed or created in the inner wall 104.

The bag leading edge 122 has affixed to it a plurality of bag attachment straps 130. The bag material 120 comprises a bag bottom edge 124, which is affixed to the apparatus 100 in the interior of the apparatus 100, to one or more of the interior surfaces of the bottom 108, the top 102, the inner wall 104, and the outer wall 106. The bag bottom edge 124 is attached to the apparatus 100 with suitable means of attachment, which means of attachment—depending on the bag material 120 used and the material of the inner wall 104, outer wall 106, top 102, and/or bottom 108, the interior of one or more of which the bag bottom edge 124 is attached—may be a glue, or may comprise heating the bag material 120 to fuse the bag bottom edge 124 to one or more interior surfaces of the apparatus 100, or may comprise other means of attachment now known or later invented. In this way, the bag material 120 will not separate from the remainder of the apparatus 100, and may hold any falling plurality of tree needles 230 that land on the bag material 120.

With reference to FIG. 3, FIG. 4, and FIG. 5, to use the apparatus 100, the apparatus 100 is placed around the tree trunk 210 of the tree 200, with the top 102 removed, before the tree 200 is placed into a tree stand 300, which tree stand 300 and tree 200 are not part of the present invention, but are common in the art and widely used. After placement of the apparatus 100 around the tree trunk 210 with the central closure and support 110 securing the apparatus 100 to the tree trunk 210, the tree 200 may be affixed in the tree stand 300, or other means of securing the tree 200 in an approximately upright position which is typically desired by the user placing the tree 200 in a location. The bag material 120 has affixed to it a plurality of bag attachment straps 130 at the bag leading edge 122. The bag leading edge 122 may be extended out of the apparatus 100 and up to a plurality of tree branches 220, which will be understood by one of skill in the art to be advantageously the lowest branches of the tree 200, whereupon the bag leading edge 122 may be secured to the plurality of tree branches 220 at or near the outermost (relative to the tree trunk 210) extent of the plurality of tree branches 220, by securing the plurality of bag attachment straps 130 to the plurality of tree branches 220. In this way, the bag material 120 forms a sheet of flexible material disposed closely under the plurality of tree branches 220 and positioned to catch all or nearly all of a plurality of tree needles 230 which may fall from the plurality of tree branches 220, solving the effectiveness problem of the prior art as falling needles or leaves will hit the sheet of bag material 120 and bounce less than off of a solid and inflexible surface, and will not have fallen as far as the ground, and will tend to bounce towards the center of the sheet, that is, towards the tree trunk 210 and the apparatus 100, because the sheet of material is roughly angled up as it extends from the tree trunk 210 to the attachment of the bag leading edge 122 to the plurality of tree branches 220.

The disposition of the apparatus 100 and the bag material 120 also solves the aesthetics problem that exists in the prior art, because the apparatus 100 is positioned on the tree trunk 210 and may be hidden by presents or other objects typically placed under the tree 200, and because the bag material 120 is close under the tree 200 and the plurality of tree branches 220, so that only the bag leading edge 122 and the bag attachment straps 130 are likely to be visible, unlike the prior art having a sheet or solid pad draped across the ground and extending beyond the diameter of the plurality of tree branches 220, and further, as will be understood by one of skill in the art, the bag material 120 may be clear and the bag attachment straps 130 may be colored to blend in with the plurality of tree branches 220 and/or the plurality of tree needles 230. The bag attachment straps 130 may be mechanical clips, or hook-and-loop type closure straps, or the bag attachment straps 130 may be holes or openings formed in the bag material 120 with or without reinforcing grommets, or may be another type of attachment component now known or later invented.

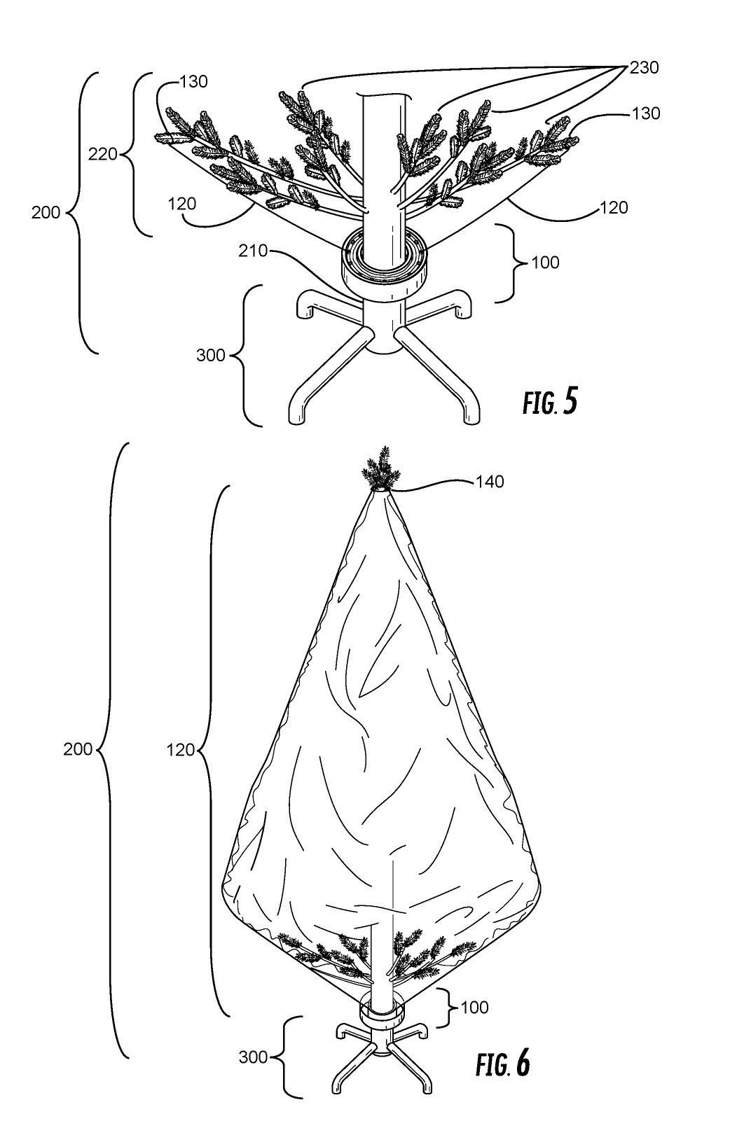

The present invention also solves the problem of ease of use, by presenting a bag material 120 in an apparatus 100 that may quickly and easily be placed around the tree trunk 210, secured to the plurality of tree branches 220, and then extended around the tree 200 and secured closed. With reference to FIG. 6, when the user is ready to move the tree 200, the user can and should detach the bag attachment straps 130 from the plurality of tree branches 220 and then extend the bag leading edge 122 out past the plurality of tree branches 220, then up and around the tree 200, so that the bag material 120 forms a continuous approximately cylindrical sheet of material surrounding the tree 200. The bag material 120 is then secured closed at or above the top of the tree 200 with a bag closure 140, which bag closure 140 may be a strap or pull closure running through the sheet of bag material 120, or may be formed by connecting a plurality of the bag attachment straps 130 to other bag attachment straps 130. As depicted in FIG. 6, the bag material 120 is shown slightly open with a small number of the plurality of tree branches 220 protruding, purely for illustrative purposes, as will be understood by one of skill in the art that the bag material 120 may and should, when used, be closed above all of the plurality of tree branches 220. Thereupon, with the tree 200 enclosed inside the bag material 120, the user may have the tree 200 removed from the location and transported without causing a mess of the plurality of tree needles 230 which would otherwise be prone to falling off of the tree 200. This solves the problem of the mess and time-consuming cleanup posed by the current art, as will be understood by one of skill in the art.

It will further be understood that the bag material 120 and the material used to make the top 102, inner wall 104, outer wall 106, bottom 108, and central closure and support 110 may all comprise biodegradable materials and substances, such that the tree 200, when disposed of, may be composted, chipped, or otherwise biologically disposed of, which will solve a problem present in the prior art, specifically the inability to enclose a tree 200 in a material and dispose of it in a biologically sustainable or compostable manner.

Without limiting the foregoing, dimensions of the apparatus 100 and its above-described components may be advantageously sized to fit typical evergreen trees used as Christmas trees, which commonly have a tree trunk 210 with a diameter of approximately 3″ to approximately 6″. The dimensions of the container of the apparatus 100 of the present invention, then, may be about 8″ to about 10″ in exterior diameter (measured from one side of the outer wall 106 through the center to the opposite side of the outer wall 106), and may be about 2″ to about 4″ tall, measuring along the outer wall 106 parallel to where the tree trunk 210 will traverse through the center of the apparatus 100. The opening in the center of the container of the apparatus 100—the interior diameter—should, it has been found advantageous, be larger than about 6″, so that the central closure and support 110 can surround a tree trunk 210 of about 6″ in diameter, and still provide the required support of the apparatus 100. The opening in the apparatus 100 through which the bag material 120 is withdrawn from the apparatus 100, which may be the top opening 103, the outer wall opening 114, the bottom opening 117, or another opening, may be approximately ¼ ″ to approximately ½″ wide, or may be another size. The respective openings, named above, may be at or near the edge of the surface of the apparatus 100, or may be within approximately 2″ of any such edge. The bag material 120 may be approximately 13′ high, and approximately 9′ in diameter, when fully extended from the apparatus 100, which sizes are sufficient to be extended around and closed around most trees used for interior decoration as the tree 200, to form the continuous approximately cylindrical sheet of bag material 120 surrounding the tree 200, in the manners described in the present disclosure.

Certain embodiments of the present invention were described above. From the foregoing it will be seen that this invention is one well adapted to attain all the ends and objects set forth above, together with other advantages, which are obvious in and inherent to the inventive apparatus disclosed herein. It will be understood that certain features and sub-combinations are of utility and may be employed without reference to other features and sub-combinations. It is expressly noted that the present invention is not limited to those embodiments described above, but rather the intention is that additions and modifications to what was expressly described herein are also included within the scope of the invention. Moreover, it is to be understood that the features of the various embodiments described herein are not mutually exclusive and can exist in various combinations and permutations, even if such combinations or permutations were not made express herein, without departing from the spirit and scope of the invention. In fact, variations, modifications, and other implementations of what was described herein will occur to those of ordinary skill in the art without departing from the spirit and the scope of the invention. As such, the invention is not to be defined only by the preceding illustrative description.

Accordingly, what is claimed is:

1. An apparatus for tree needle or leaf catchment and tree transport, the apparatus to be placed on the trunk of a tree, the apparatus comprising:
a container comprising a top, an inner wall, an outer wall, and a bottom;
a central closure and support fixedly attached to the inner wall and extending inward from the inner wall;
bag material inside the container, the bag material being formed as a cylindrical sheet of material, which bag material is initially folded, and which bag material comprises a bag leading edge and a bag bottom edge, wherein the bag leading edge has affixed to it a plurality of bag attachment straps, and the bag bottom edge of the bag material is affixed to the apparatus in the interior of the apparatus, to one or more of the interior surfaces of the bottom, the top, the inner wall, and the outer wall; and
wherein the bag leading edge may be extended out of the apparatus and secured to a plurality of tree branches by securing the plurality of bag attachment straps to the plurality of tree branches, such that the bag material forms a sheet of flexible material disposed closely under the plurality of tree branches; and
wherein the bag material may form a continuous approximately cylindrical sheet of material surrounding the tree, and the bag material may be secured closed at or above the top of the tree with the bag closure; and
wherein the dimensions of the container are about 8″ to about 10″ in exterior diameter, and about 2″ to about 4″ tall; and
wherein the opening in the center of the container is larger than about 6″;
and wherein the opening in the apparatus through which the bag material is withdrawn from the apparatus is approximately ¼″ to approximately ½″ wide, and is within approximately 2″ of any such edge of the container;
and wherein the bag material is approximately 13′ high, and approximately 9′ in diameter.

2. The apparatus for tree needle or leaf catchment and tree transport of claim 1, the apparatus' central closure and support further comprising a plurality of central closure and support perforations.

3. The apparatus for tree needle or leaf catchment and tree transport of claim 1, in which the bag attachment straps are holes or openings formed in the bag material.

4. An apparatus for tree needle or leaf catchment and tree transport, the apparatus to be placed on the trunk of a tree, the apparatus comprising:
a container comprising a top, an inner wall, an outer wall, and a bottom;
a central closure and support fixedly attached to the inner wall and extending inward from the inner wall;
bag material inside the container, the bag material being formed as a cylindrical sheet of material, which bag material is initially folded, and which bag material comprises a bag leading edge and a bag bottom edge, wherein the bag leading edge has affixed to it a plurality of bag attachment straps, and the bag bottom edge of the bag material is affixed to the apparatus in the interior of the apparatus, to one or more of the interior surfaces of the bottom, the top, the inner wall, and the outer wall; and
a bag closure; and
wherein the dimensions of the container are about 8″ to about 10″ in exterior diameter, and about 2″ to about 4″ tall; and
wherein the opening in the center of the container is larger than about 6″;
and wherein the opening in the apparatus through which the bag material is withdrawn from the apparatus is approximately ¼″ to approximately ½″ wide, and is within approximately 2″ of any such edge of the container;
and wherein the bag material is approximately 13′ high, and approximately 9′ in diameter.

5. An apparatus for tree needle or leaf catchment and tree transport, the apparatus to be placed on the trunk of a tree, the apparatus comprising:
a container comprising a top, an inner wall, an outer wall, and a bottom;
a central closure and support fixedly attached to the inner wall and extending inward from the inner wall;
bag material inside the container, the bag material being formed as a cylindrical sheet of material, which bag material is initially folded, and which bag material comprises a bag leading edge and a bag bottom edge, wherein the bag leading edge has affixed to it a plurality of bag attachment straps, and the bag bottom edge of the bag material is affixed to the apparatus in the interior of the apparatus, to one or more of the interior surfaces of the bottom, the top, the inner wall, and the outer wall; and
a bag closure; and
wherein the bag leading edge may be extended out of the apparatus and secured to a plurality of tree branches by securing the plurality of bag attachment straps to the plurality of tree branches, such that the bag material forms a sheet of flexible material disposed closely under the plurality of tree branches; and
wherein the bag material may form a continuous approximately cylindrical sheet of material surrounding the tree, and the bag material may be secured closed at or above the top of the tree with the bag closure.

6. The apparatus for tree needle or leaf catchment and tree transport of claim 5, the apparatus' central closure and support further comprising paper or cellulose products.

7. The apparatus for tree needle or leaf catchment and tree transport of claim 5, the apparatus' central closure and support further comprising one piece of material.

8. The apparatus for tree needle or leaf catchment and tree transport of claim 5, the apparatus' central closure and support further comprising more than one layer of material.

9. The apparatus for tree needle or leaf catchment and tree transport of claim 5, the apparatus' central closure and support further comprising material which is a solid sheet.

10. The apparatus for tree needle or leaf catchment and tree transport of claim 5, the apparatus' central closure and support further comprising material which is perforated with a plurality of central closure and support perforations.

11. The apparatus for tree needle or leaf catchment and tree transport of claim 10, the plurality of central closure and support perforations being arranged so that the separated portions of the central closure and support are formed as separate shapes.

12. The apparatus for tree needle or leaf catchment and tree transport of claim 5, the apparatus' central closure and support further comprising material which has a hollow opening in the center of the central closure and support.

13. The apparatus for tree needle or leaf catchment and tree transport of claim 5, in which the top or a portion of the top can be removed along top removal perforations.

14. The apparatus for tree needle or leaf catchment and tree transport of claim 5, in which an outer wall opening can be created by removal of a portion of the outer wall along a set of outer wall removal perforations.

15. The apparatus for tree needle or leaf catchment and tree transport of claim 5, in which a bottom opening may be created by removal of a portion of the bottom along a set of bottom removal perforations.

16. The apparatus for tree needle or leaf catchment and tree transport of claim 5, in which the bag attachment straps are mechanical clips.

17. The apparatus for tree needle or leaf catchment and tree transport of claim 5, in which the bag attachment straps are holes or openings formed in the bag material.

18. The apparatus for tree needle or leaf catchment and tree transport of claim 5, in which the bag closure is a strap or pull closure running through the bag material.

19. The apparatus for tree needle or leaf catchment and tree transport of claim 5, in which the bag closure is formed by connecting a plurality of the bag attachment straps to other bag attachment straps.

20. The apparatus for tree needle or leaf catchment and tree transport of claim 5, in which the material used to make the bag material, top, inner wall, outer wall, bottom, and central closure and support comprise biodegradable materials.
